(19) United States
(12) Patent Application Publication
(10) Pub. No.: US 2024/0198368 A1
(43) Pub. Date: Jun. 20, 2024

(54) ELECTRODE COMPOSITION FOR ELECTROSPRAYING

(71) Applicant: AMOGREENTECH CO., LTD., Gimpo-si (KR)

(72) Inventors: Young Hwan JEON, Gimpo-si (KR); Seung Hyun LEE, Gimpo-si (KR); Hae Won JANG, Gimpo-si (KR)

(73) Assignee: AMOGREENTECH CO., LTD., Gimpo-si (KR)

(21) Appl. No.: 18/286,143

(22) PCT Filed: Apr. 11, 2022
(86) PCT No.: PCT/KR2022/005221

§ 371 Date: Dec. 1, 2023

(30) Foreign Application Priority Data
Apr. 9, 2021 (KR) 10-2021-0046504
Apr. 9, 2021 (KR) 10-2021-0046505

(51) Int. Cl. B05B 5/053

(52) U.S. Cl. CPC B05B 5/0536

(57) ABSTRACT

An electrode composition for electrospraying is configured for obtaining an electrode having an average thickness of at most 1.0 μm when dry, and includes a conductive metal powder having an average particle diameter of at most 150 nm, a ceramic powder, a binder resin, and a solvent. Accordingly, the electrode composition is suitable for obtaining, via electrospraying, an electrode pattern that has excellent thickness uniformity while also being an ultra-thin film. In addition, the obtained electrode has excellent electrical conductivity. Furthermore, the electrode composition is suitable for forming an electrode on a ceramic sheet such as a green sheet. When the formed electrode is co-sintered with a ceramic green sheet, the shape of the sintered body is maintained intact, and interlayer separation of the sintered body may be prevented. Moreover, an ultra-thin film electrode is obtained and widely used as an internal electrode for a highly laminated multilayer ceramic part.

### CROSS REFERENCE TO THE RELATED APPLICATIONS

This application is the national phase entry of International Application No. PCT/KR2022′005221, filed on Apr. 11, 2022, which is based upon and claims priority to Korean Patent Applications No. 10-2021-0046504 and No. 10-2021-0046505, both filed on Apr. 9, 2021, the entire contents of which are incorporated herein by reference.

### TECHNICAL FIELD

The present invention relates to an electrode composition, and more specifically to an electrode composition for electrospray.

### BACKGROUND

Among the electronic components widely used in electronic devices, elements such as capacitors, capacitors, varistors, suppressors and MLCCs correspond to co-sintered laminated ceramic parts that implement a single device by laminating several to hundreds of green sheets with printed electrode patterns and then co-sintering the electrodes and green sheets, and recently, in line with the miniaturization and higher performance of electronic devices, much research is being conducted to miniaturize and increase the capacity of these devices.

In the case of such co-sintered type laminated ceramic parts, in addition to improving the materials of the dielectric and electrode constituting the green sheet for high capacity, attempts for high lamination by laminating a larger number of green sheets are continuing. In order to achieve high lamination of co-sintered type laminated ceramic parts, a reduction in the thickness of the overall green sheet and electrode pattern is required, and for miniaturization, it is essentially required to refine the electrode line width of the electrode pattern and the spacing between electrodes.

Meanwhile, the conventional method of printing an electrode pattern on a green sheet has used a screen printing method or a gravure printing method, and the screen printing method or the gravure printing method has an advantage of low cost. However, since these methods can implement only the electrode line width and the inter-electrode spacing at the level of 40 to 80 μm, it is difficult to form a smaller and more sophisticated fine pattern with these methods. In addition, since it is difficult to form an ultra-thin electrode pattern of 1 μm or less with an electrode thickness of 5 to 100 μm after printing, there are problems in that it is difficult to form the internal electrodes of highly laminated and miniaturized co-sintered laminated ceramic parts by using the conventional screen printing or gravure printing methods. Further, in order to print ultra-thin electrodes, the viscosity of the electrode composition for printing must be significantly lowered, which causes problems with printing bleeding and reduced printing resolution.

As such, in recent years, attempts have been made to implement a fine-patterned electrode by the inkjet printing method, but when an electrode is formed by using inkjet printing, it is possible to implement an ultra-thin electrode pattern with a thickness of 1 μm or less, but the productivity is not good, and there are problems in that the cost of ink for electrode production is high, and it is not easy to print electrode patterns on large-area green sheets.

Accordingly, the situation is that there is an urgent need to develop a method for easily and inexpensively forming an ultra-thin electrode pattern on a large-area green sheet, and an electrode composition that is suitable therefor.

### SUMMARY

### Technical Problem

The present invention has been devised in view of the above points, and it is an object of the present invention to provide an electrode composition for electrospray which is suitable for printing an electrode pattern having an ultra-thin film and excellent thickness uniformity on a ceramic sheet such as a green sheet by using the electrospray method.

In addition, it is another object of the present invention to provide an electrode composition for electrospray that implements an electrode having excellent electrical conductivity and prevents shape deformation or interlayer separation of a sintered body due to a difference in shrinkage characteristics that occurs during simultaneous sintering after being printed on a ceramic sheet such as a green sheet.

### Technical Solution

In order to solve the above-described problems, the present invention provides an electrode composition for electrospraying, which is an electrode composition for electrospraying for implementing an electrode having an average thickness of 1.0 μm or less when dried, including a conductive metal powder having an average particle diameter of 150 nm or less, a ceramic powder, a binder resin and a solvent.

According to an exemplary embodiment of the present invention, the electrode composition for electrospraying may be an electrode composition for implementing an internal electrode of a laminated ceramic part.

In addition, the conductive metal powder may have an average particle diameter of 80 nm or less.

Further, in the conductive metal powder, the number of particles having a particle diameter of 2 times or more of the average particle diameter may be 20% or less of the total number of conductive metal powders, and the number of particles having a particle diameter of 0.5 times or less of the average particle diameter may be 20% or less of the total number of conductive metal powders.

In addition, the conductive metal powder may include at least one of a metal selected from the group consisting of Ni, Mn, Cr, Al, Ag, Cu, Pd, W, Mo and Co, an alloy comprising at least one of the same, and a mixed metal comprising at least two of the same.

In addition, the ceramic powder may have an average particle diameter of 0.1 to 0.5 times of the average particle diameter of the conductive metal powder.

In addition, the ceramic powder may include at least one ceramic powder selected from the group consisting of titania, alumina, silica, cordierite, mullite, spinel, barium titanate, calcium zirconia and zirconia.

In addition, the conductive metal powder may be provided in an amount of 10 to 30 wt. % based on the total weight.

In addition, the ceramic powder may be included in an amount of 4 to 10 parts by weight based on 100 parts by weight of the conductive metal powder.

In addition, the binder resin may be included in an amount of 2 to 13 parts by weight based on 100 parts by weight of the conductive metal powder.

In addition, the ceramic powder may have an average particle diameter of 45 nm or less.

In addition, the binder resin may include 30 to 60 parts by weight of ethylcellulose based on 100 parts by weight of polyvinyl butyral.

In addition, the electrode composition may have a viscosity of 50 to 150 cps at 25° C.

In addition, the present invention provides an electrospray electrode, which is an electrode that is dried after the electrode composition for electrospraying according to the present invention is electrosprayed on a predetermined area and has an average thickness of 1 μm or less.

In addition, according to an exemplary embodiment of the present invention, the electrospray electrode may have a thickness uniformity of 10% or less.

In addition, the present invention provides a laminated ceramic part, including an internal electrode in which the electrospray electrode according to the present invention is sintered.

### Advantageous Effects

The electrode composition for electrospraying according to the present invention is suitable for obtaining, via electrospraying, an electrode pattern that has excellent thickness uniformity while also being an ultra-thin film. In addition, the obtained electrode may have excellent electrical conductivity. Furthermore, the electrode composition may be suitable for forming an electrode on a ceramic sheet such as a green sheet. Moreover, when the formed electrode is co-sintered with a ceramic green sheet, the shape of the sintered body may be maintained intact, and interlayer separation of the sintered body may be prevented. In addition, since an ultra-thin film electrode can be obtained, the electrode can be widely used as an internal electrode for a highly laminated multilayer ceramic part.

### BRIEF DESCRIPTION OF THE DRAWINGS

FIG. 1 is a SEM photograph of a nickel powder having an average particle diameter of 75 nm as a conductive metal powder included in an exemplary embodiment of the present invention.

FIG. 2 is an SEM photograph of the nickel powder according to FIG. 1 before wet classification.

FIG. 3 is a SEM photograph of barium titanate powder as a ceramic powder included in an exemplary embodiment of the present invention.

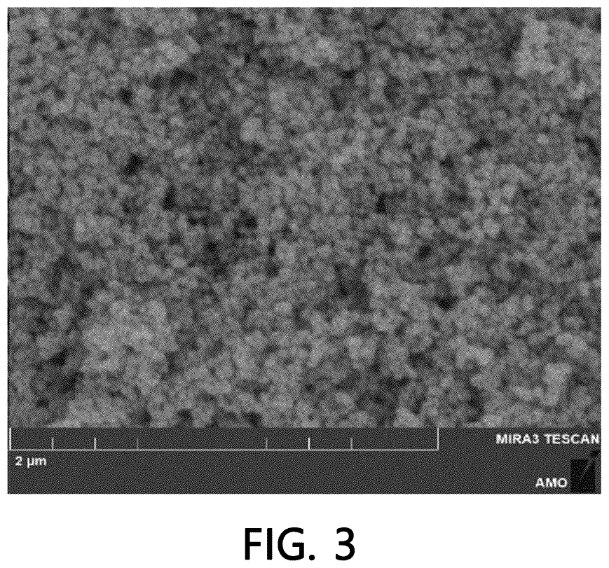

FIGS. 4 and 5 are photographs of the electrode composition for electrospraying containing the nickel powder according to FIGS. 1 and 2, respectively, and FIG. 4 is a photograph which is uniformly dispersed with the ceramic powder without precipitation of the nickel powder, and FIG. 5 is a photograph showing phase separation from ceramic powder due to precipitation of nickel powder.

FIGS. 6 and 7 are optical microscope images of electrodes dried after electrospraying the electrode composition for electrospraying, respectively, and FIG. 6 is a photograph of an electrode pattern with excellent continuous electrode surface formation without any unformed portions of the electrode pattern, and FIG. 7 is a photograph of an electrode pattern in which a continuous electrode surface was partially not formed due to the presence of a portion in the electrode pattern where the electrode was not formed (circled portion).

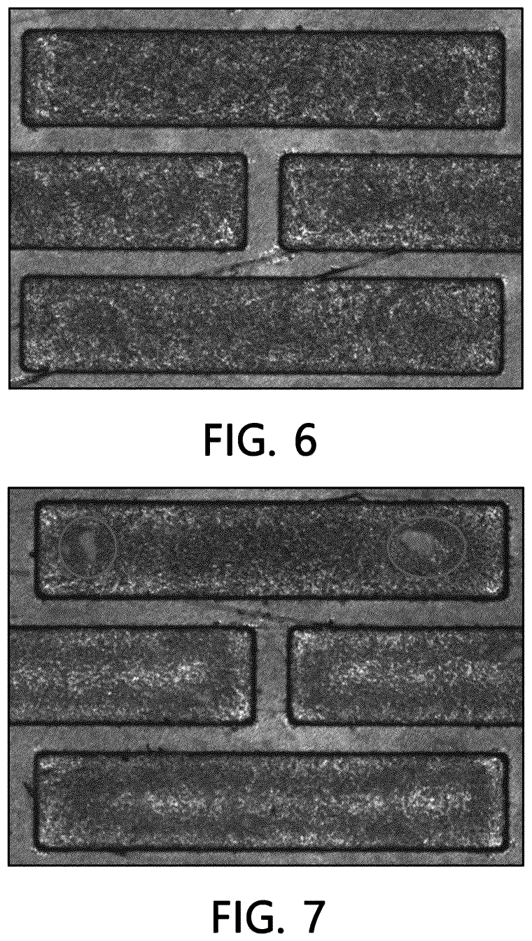

FIGS. 7 and 8 are optical microscope images of an electrode dried after electrospraying the electrode composition for electrospraying, and FIG. 7 is a photograph of an electrode pattern with excellent continuous electrode surface formation without unformed portions of the electrode pattern, and FIG. 8 is a photograph of an electrode pattern in which a continuous electrode surface was partially not formed due to the presence of partially dropped electrodes in which electrodes were not formed in the electrode pattern.

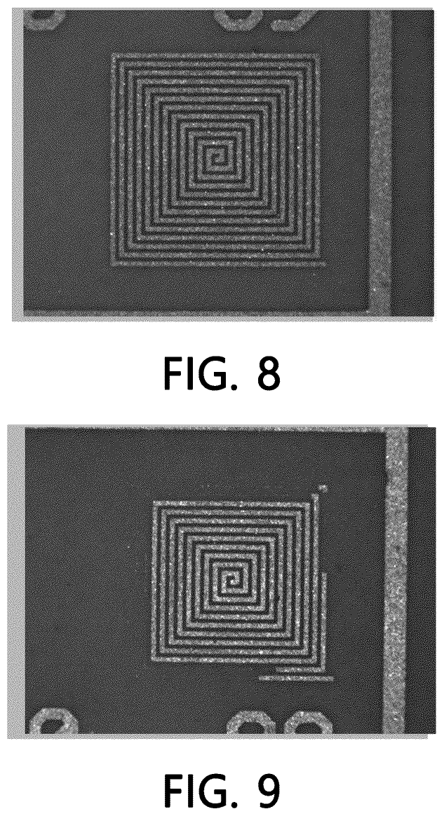

### DETAILED DESCRIPTION OF THE EMBODIMENTS

Hereinafter, the exemplary embodiments of the present invention will be described in detail so that those of ordinary skill in the art can easily practice the present invention. The present invention may be embodied in many different forms and is not limited to the exemplary embodiments described herein.

The electrode composition according to an exemplary embodiment of the present invention is suitable for the electrospray method and is an electrode composition which is capable of implementing an ultra-thin electrode having an average thickness of 1.0 μm, and preferably, 0.6 μm or less when dried, and it is implemented by including a conductive metal powder with an average particle diameter of 150 nm or less, a ceramic powder, a binder resin and a solvent. In addition, since it is suitable for forming electrodes on green sheets and can implement ultra-thin electrodes, it may be particularly suitable for implementing internal electrodes of laminated ceramic parts such as MLCC and the like that require high lamination.

The conductive metal powder imparts conductivity and forms the body of the electrode after sintering, and the conductive metal powder that is commonly used for manufacturing electrodes for electronic components may be used without limitation. For example, the conductive metal powder may include at least any one of a metal selected from the group consisting of nickel, manganese, chromium, aluminum, silver, copper, palladium, tungsten, molybdenum and cobalt, an alloy including at least one of the same, and a mixed metal including at least two of the same. However, in consideration of the sintering temperature when co-sintering with the ceramic green sheet, it may include at least one selected from the group consisting of palladium, silver-palladium alloy, silver, nickel and copper, and in consideration of heat resistance, conductivity and material cost, it may more preferably include nickel.

In addition, the conductive metal powder may have an average particle diameter of 150 nm or less, preferably, 100 nm or less, and more preferably, 80 nm or less, and if the average particle diameter of the conductive metal powder is more than 150 nm, the thickness of the dried electrode after electrospraying may exceeds 1 μm, or it is difficult to form a continuous electrode surface for the implemented dried electrode, and even if a dried electrode with a thickness of 1 μm is implemented, the thickness uniformity may be very uneven, and as a result, it may be difficult to implement high-quality, highly laminated multilayer ceramic parts. Meanwhile, the conductive metal powder may have an average particle diameter of 5 nm or more, more preferably, 10 nm or more, and still more preferably, 20 nm or more, and if the average particle diameter is less than 5 nm, it is not easy to implement the conductive metal powder itself, and material costs may increase. In addition, as the metal powder is reduced to fine particles, securing dispersibility is required, but degreasing may not be easy due to organic compounds such as dispersants that are added to ensure dispersibility, and as a result, when laminated ceramic parts are sintered, separation between green sheet layers may occur. In addition, if no separate dispersant is included, when the average particle size of the conductive metal powder is too small, the dispersibility is reduced, and when it aggregates to form coarse secondary particles, it is undesirable because it is difficult for the implemented dried electrode to form a continuous electrode surface or the thickness unevenness may worsen.

Further, in the conductive metal powder, the number of particles having a particle diameter of two times or more of the average particle diameter is 20% or less of the total number of conductive metal powders, more preferably, 15% or less, still more preferably 10% or less, and even more preferably, 5% or less, and the number of particles having a particle diameter of 0.5 times or less of the average particle diameter may have a particle size distribution of 20% or less, and more preferably, 10% or less, of the total number of conductive metal powders, and through this, it is suitable for minimizing the agglomeration of conductive metal powder in the electrode composition supplied for electrospraying to form secondary particles, and minimizing or preventing the sedimentation of conductive metal powder inside a spinning solution chamber in the electrospray device. In addition, through this, it is advantageous to form a continuous electrode surface in which there is no area in the dried electrode where the electrode composition is not partially sprayed, and it may be advantageous to prevent deterioration of the appearance quality of the electrode, such as uneven electrical characteristics such as resistance at each position of the electrode formed by electrospraying, or uneven thickness of the implemented electrode.

In addition, the conductive metal powder may be provided in an amount of 30 wt. % or less, more preferably, 10 to 30 wt. %, and still more preferably, 20 to 30 wt. % based on the total weight of the electrode composition. If the conductive metal powder is included in excess of 30 wt. %, sedimentation or precipitation of the conductive metal powder in the electrode composition supplied for electrospray may occur, and as a result, the conductive powder may be non-uniformly sprayed during electrospray. In addition, it may be difficult to control the thickness of the electrode implemented by electrospray. In addition, when the conductive metal powder is provided in an amount of less than 10 wt. %, the electrosprayed dried electrode or sintered electrode may form an island such as a water droplet, and as a result, it may be difficult to implement the desired electrode, such as the continuous formation of the electrode surface being reduced or the dried electrode thickness becoming uneven.

Meanwhile, due to the above-described conductive metal powder, the electrode composition has high electrical conductivity, and electric spraying may be difficult due to the high electrical conductivity. Accordingly, the electrode composition includes the ceramic powder, and through this, the electrode composition may be adjusted to an electrical conductivity that is suitable for electrospray. In addition, the electrode composition is processed on the green sheet so as to prevent shape deformation such as the sintered body being crushed due to differences in the sintering temperature between the electrode and the green sheet and the shrinkage characteristic due to differences in the sintering temperature generated during simultaneous sintering. Furthermore, after sintering, the ceramic part derived from the ceramic powder may move toward the surface of the sintered electrode and be layer-separated from the conductive component derived from the sintered conductive metal powder, and through this, since it is possible to increase the dielectric constant, it may contribute to improving the characteristics of laminated ceramic parts such as MLCC and the like.

In addition, the ceramic powder may have an average particle diameter of 100 nm or less, and in another example, it may be 70 nm or less, 45 nm or less, or 1 to 30 nm. Further, in consideration of the average particle diameter of the conductive metal powder, ceramic powder having an appropriate average particle diameter may be used. Specifically, the ceramic powder having a smaller average particle diameter of 0.5 times or less, and more preferably, 0.3 times or less of the average particle diameter of the conductive metal powder may be used, and through this, it is advantageous to delay the shrinkage of the electrode faster than the green sheet during sintering. For example, when the conductive metal powder having an average particle diameter of 80 nm is used, the average particle diameter of the ceramic powder may be 20 nm or less. However, when the average particle diameter of the ceramic powder becomes smaller than the average particle diameter of the conductive metal powder by 0.1 times or less, the amount of resin added may have to be increased due to an increase in the surface area of the particles, and there is a risk of causing uneven thickness of the dried and/or sintered electrode, and the shrinkage rate of the electrode increases during sintering, which may be undesirable.

Meanwhile, the ceramic powder may also be advantageous to maintain a uniform dispersed phase as the proportion of coarse particles having a particle diameter of two times or more compared to the average particle diameter is small. Accordingly, in the ceramic powder, the number of particles having a particle diameter of two times or more of the average particle diameter may be 20% or less, more preferably, 10% or less, and still more preferably, 5% or less of the total number of ceramic powder particles.

In addition, the ceramic powder may be used without limitation in the case of known ceramic powder, but for example, it may include at least one or more ceramic powders selected from the group consisting of titania, alumina, silica, cordierite, mullite, spinel, barium titanate and zirconia. In this case, when the ceramic powder is used to form an internal electrode by electrospraying the electrode composition on the green sheet, it may be selected as a component that is common to the dielectric component of the green sheet, and through this, during co-sintering, it may be easier to control the shrinkage characteristics between the green sheet and the electrode, and it may be advantageous to improve the bonding and adhesion characteristics between the electrode and the green sheet. Meanwhile, when the ceramic powder is barium titanate, it is noted that (Ba₁₋ₓCaₓ)TiO₃, Ba(Ti_{1-y}Ca_{y})O₃, (Ba₁₋ₓCaₓ)(Ti_{1-y}Zr_{y})O₃ or Ba(Ti_{1-y}Zr_{y})O₃, in which Ca and Zr are partially employed, also falls within the category of barium titanate.

In addition, the ceramic powder may be included in an amount of 4 to 10 parts by weight, and more preferably, 4 to 7 parts by weight, based on 100 parts by weight of the conductive metal powder. If the amount of the ceramic powder is provided at less than 4 parts by weight, the thickness control of the implemented electrode may be difficult. In addition, it is difficult to control the shrinkage characteristics during simultaneous sintering with the ceramic green sheet, and cracks and peeling of the electrode implemented after sintering may occur frequently. In addition, if the ceramic powder is contained in excess of 10 parts by weight, the electrical conductivity of the implemented electrode is lowered, and there is a concern that the degree of contraction of the electrode during sintering may be excessive.

Meanwhile, in the present invention, the particle diameters of the conductive metal powder and the ceramic powder are values based on particle size measurement by the dynamic light scattering method and are volume-based particle diameters, and the average particle diameter means a particle diameter corresponding to D50 in the cumulative volume-based particle size distribution. In addition, the measuring device may be a known measuring device which is capable of counting nano-sized powder particle size, and for example, it may be a measuring device such as a Zetasizer series, APS-100 or the like.

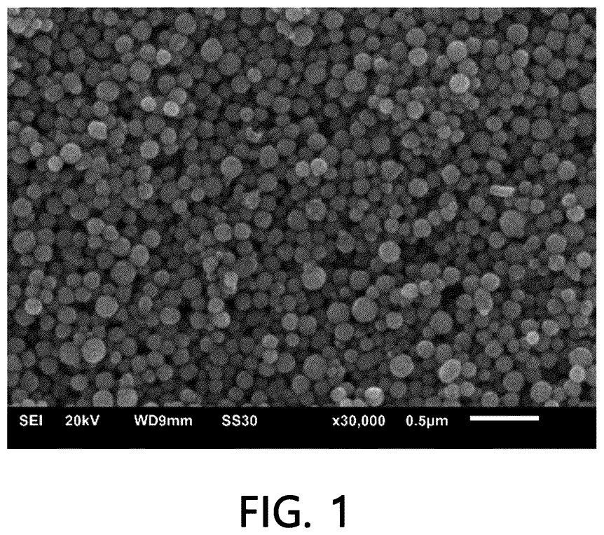

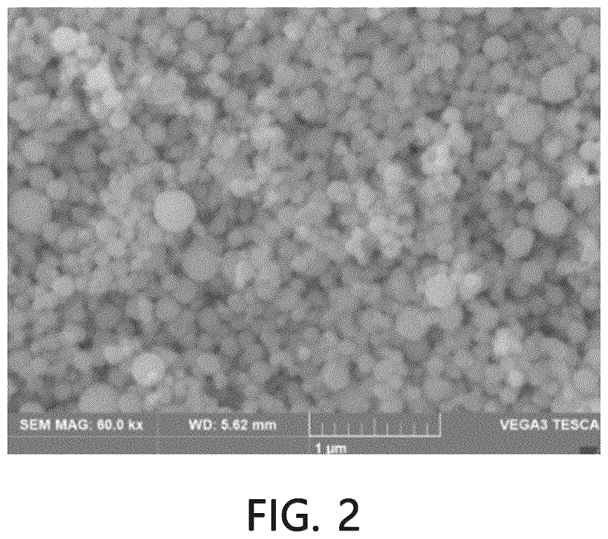

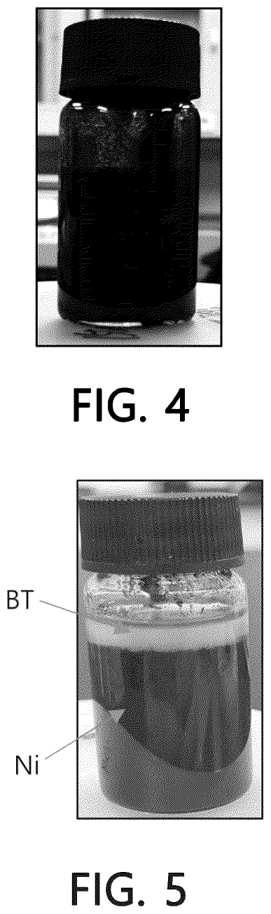

In addition, the conductive metal powder having an average particle diameter of 150 nm or less may be implemented by using the dry plasma powder synthesis method such as PVD or CVD, which can be advantageous for preparing a powder with a clean particle surface. In addition, it may be advantageous to obtain a conductive metal powder having a desired particle size and distribution by performing a wet classification process using a known natural fall method or centrifugal separation on the conductive metal powder obtained by using the dry plasma powder synthesis method. In this case, it is preferable to use forced classification by centrifugation, and the use of a continuous centrifuge is preferable for production efficiency. The continuous centrifuge may control the average particle size by controlling the rotational speed and the input amount per minute of the centrifuge, and the number ratio of coarse particles that cause rapid sedimentation of the conductive metal powder in the electrode composition and impair uniform dispersion, for example, conductive metal powder with a particle diameter of two times or more of the average particle diameter, may be controlled to be small. If the rotation speed of the centrifuge is too high, the production yield is greatly reduced, and if it is too low, the removal rate of coarse particles that impede uniform dispersion is reduced. In addition, if the input amount is too large, the time to receive a centrifugal force in the centrifuge chamber is shortened, making the removal of large particles difficult, and if the amount is too small, the efficiency improves, but the production time increases, which may be undesirable. In addition, a filtration process may be further performed to precisely control the particle size distribution of the conductive metal powder to the desired level, and in this case, since the filtration process may be performed through a conventional process of removing coarse particles by using a known filter medium, the present invention is not particularly limited thereto. Specifically, FIG. 1 is an SEM photograph of the conductive metal powder used in Example 4, and as the particle size of the conductive metal powder shown in FIG. 2 is adjusted to have a low coarse particle ratio through wet classification through centrifugation, it can be seen that the electrode composition shown in FIG. 4 has a good dispersion state. In contrast, when there are many coarse particles of the conductive metal powder, it can be confirmed that as shown in FIG. 5, the conductive metal powder was greatly sedimented and phase-separated from the ceramic powder.

In addition, the ceramic powder may be prepared by appropriately utilizing a known powder technology and a particle control technology to have a desired particle size distribution by using a commercially available ceramic powder, and as a specific means, it may be prepared through various known grinding and classification methods, related devices and adjustment of factors such as grinding conditions and grinding time by using the same. For example, in the case of a pulverizer, it is possible to control the grinding level by using any one of a mechanical pulverizer using a braid mill or super rotor, or an airflow pulverizer that pulverizes particles by colliding with the wall using a high-speed air stream of high-pressure air, or by using a method in which the pulverized material from any one thereof is introduced back into another pulverizer to be pulverized. In addition, a classifier that classifies a pulverized material such as a centrifugal wind power disperser, a disperser that uses physical dispersion power such as high-speed airflow to prevent the agglomeration of fine particles, or the wet classification method may be used to classify ceramic powder to have the desired particle size distribution through centrifugation, and the present invention omits the detailed description thereof.

In addition, the electrode composition includes a binder resin along with the conductive metal powder and ceramic powder described above, and through this, electrode formation through electrospraying and adhesion characteristics with the electrosprayed surface may be achieved. The binder resin may be used without limitation in the case of a binder resin used in a typical electrode composition, and for example, polyvinyl butyral, polyvinyl butyraldehyde, polyvinyl alcohol, acrylic resin, epoxy resin, phenolic resin, alkyd resin, cellulose polymer, rosin resin and the like may be used. However, considering electrode printability through electrospraying and adhesion and attachment to the electrosprayed surface, particularly, the green sheet surface, the binder resin may be used by mixing polyvinyl butyral and ethylcellulose. In this case, the binder resin may include 30 to 60 parts by weight of ethylcellulose based on 100 parts by weight of polyvinyl butyral, and through this, it is possible to exhibit more improved printability and surface adhesion characteristics. If ethylcellulose is provided by exceeding 60 parts by weight, during electrospraying, the size of the slurry particles sprayed from the spray nozzle may not be fine, and after electrospraying, the dried electrode film becomes excessively hard, reducing adhesion to the electrosprayed surface, and there is a concern that the electrode may peel off from the sprayed surface during sintering. In addition, if ethylcellulose is provided at less than 30 parts by weight, electrode printability through electrospraying may be reduced.

In addition, it is preferable to use polyvinyl butyral and ethyl cellulose having a weight average molecular weight of 100,000 or less, and in another example, 10,000 to 100,000, and through this, it may be easy to implement a viscosity that is suitable for electrospray. If the weight average molecular weight exceeds 100,000, electrospray may become difficult due to excessive viscosity increase.

In addition, the binder resin may be included in an amount of 13 parts by weight or less, more preferably, 10 parts by weight or less, and still more preferably, 2 to 10 parts by weight based on 100 parts by weight of the conductive metal powder. If the binder resin exceeds 13 parts by weight, cracks may occur in the electrode during sintering, or separation between the laminated green sheet layers may be caused in the case of sintering together with the green sheet. In addition, if the binder resin is less than 2 parts by weight, there is a concern that sedimentation of the metal powder or ceramic powder in the electrode composition or dispersibility may be impaired, and there is a concern that the electrode may be peeled off from the surface that is sprayed before drying and sintering after spraying.

In addition, the electrode composition includes a solvent, and for the solvent, a solvent that is used in a known electrode composition that can be employed in a spray solution during electrospraying and can dissolve a binder resin without affecting the electrosprayed surface, such as green sheets and the above-described conductive metal powder and ceramic powder, may be selected without limitation. For example, at least one organic solvent such as dihydroterpineol, dihydroterpineol acetate, terpineol, octanol, n-paraffin, decanol, tridecanol, dibutyl phthalate, butyl acetate, butyl carbitol, butyl carbitol acetate, isobornyl acetate, isobornyl propionate, isobornyl butyrate, isobornyl isobutyrate, ethylene glycol monobutyl ether acetate, dipropylene glycol methyl ether acetate, ethyl acetate, butyl acetate, hexyl acetate and the like, and preferably, at least one organic solvent of a mixed solvent of dihydroterpineol and dihydroterpineol acetate or a mixed solvent of dihydroterpineol acetate and ethyl acetate may be used, and preferably, a mixed solvent of dihydroterpineol and dihydroterpineol acetate may be used.

Meanwhile, the electrode composition for electrospray according to an exemplary embodiment of the present invention may be implemented as a photosensitive electrode composition. To this end, the binder resin may include a photosensitive resin, and the photosensitive electrode composition may further include a monomer and a photoinitiator.

The binder resin includes a photosensitive resin, and the photosensitive resin serves as a binder for the components in the photosensitive electrode composition, and performs a function of maintaining the bonding force of the dried electrode and a function of imparting solubility in a developing solution. The photosensitive resin may be cured by intermolecular crosslinking under the action of active energy such as ultraviolet rays or electron beams to form a cured film, or the intermolecular crosslinking may be broken and dissolved in a developing solution.

The photosensitive resin may be used without limitation as long as it is a photosensitive resin that is commonly used in the field of photosensitive electrode paste. In addition, it may be a positive-type or negative-type photosensitive resin. For example, the photosensitive resin may be a photosensitive binder resin used in photosensitive resin compositions such as acrylate-based, cellulose-based, novolak acrylic, water-soluble polymer, polyimide or precursors thereof. However, the photosensitive resin may preferably be a negative-type acrylate-based photosensitive binder. For the acrylate-based photosensitive binder, various conventionally known photosensitive resins (photosensitive prepolymers), such as resins having ethylenically unsaturated bonds such as vinyl, allyl, acryloyl and methacryloyl groups or photosensitive functional groups such as propargyl groups, and for example, acrylic copolymers having ethylenically unsaturated groups in the side chains, unsaturated carboxylic acid-modified epoxy resins or resins to which a polybasic acid anhydride is added may be used. Specifically, the photosensitive resin may include an acrylate-based copolymer in which at least two monomers of glycidyl methacrylate (GMA), methyl methacrylate (MMA), isobornyl methacrylate (IBOMA), benzyl methacrylate, methacrylic acid (MMA), acrylic acid (AA) and styrene monomer are copolymerized. As a more specific example, the photosensitive resin may be a glycidyl methacrylate-methyl methacrylic acid copolymer, a glycidyl methacrylate-methyl methacrylic acid-methyl methacrylate-isobornyl methacrylate copolymer or a methyl methacrylate-benzyl methacrylate-methacrylic acid copolymer.

In addition, the photosensitive resin according to an exemplary embodiment of the present invention is a copolymer in which methacrylic acid, methyl methacrylate and isobornyl methacrylate are copolymerized, which may include an acrylate-based copolymer containing 15.5 to 19.5 mol % of methacrylic acid and having a weight average molecular weight of 8,000 to 15,000, and more specifically, it may be a copolymer containing 25 to 40 mol % of methyl methacrylate and the remainder of isobornyl methacrylate, and through this, it may be advantageous to implement an electrode pattern with superior quality, resolution and photosensitivity and to prevent residues.

In addition, the acrylate-based copolymer may be introduced by reacting a compound having an epoxy or isocyanate functional group to a carboxy functional group in the acrylate-based copolymer in order to control the acid value. In this case, the compound having the epoxy group may include, for example, at least one of a methylene functional group, a vinyl functional group and an allyl functional group at the terminal, and specifically, it may be allyl glycidyl ether. In addition, the compound having the isocyanate functional group may be, for example, 2-acryloyloxyethyl isocyanate.

In addition, the acrylate-based copolymer with the controlled acid value may have an acid value of 25 to 100 mgKOH/g, and through this, it is possible to exhibiting excellent photosensitivity and developability.

In addition, the glass transition temperature of the photosensitive resin as the acrylate-based copolymer may be 20 to 150° C.

In addition, according to an exemplary embodiment of the present invention, as the photosensitive resin, polyimide or a precursor thereof may be included in addition to the acrylate-based photosensitive resin. In this case, the content of polyimide or a precursor thereof may be included in an amount of 10 to 60 parts by weight based on 100 parts by weight of the acrylate-based resin, and through this, it may be more advantageous in achieving the objects of the present invention.

Meanwhile, the binder resin including the photosensitive resin may further include a polyvinyl butyral resin. The binder resin made of only the photosensitive resin may have poor adhesion to the electrosprayed surface, for example, a green sheet. Accordingly, it may further include a polyvinyl butyral resin, and it is possible to achieve improved adhesion and attachment to the green sheet. The polyvinyl butyral resin may be contained at 10 to 50 wt. % of the binder resin, and if it is included in an amount exceeding 50 wt. %, there is a concern that defects such as residues during development after exposure may increase, and if it is contained at less than 10 wt. %, the effect of improving adhesion may be insignificant. In this case, considering that the polyvinyl butyral resin must maintain a low viscosity of the electrode composition to be implemented, preferably, it is preferable to use the polyvinyl butyral resin having a weight average molecular weight of 100,000 or less, for example, 10,000 to 100,000.

In addition, the monomer contains a carbon double bond, and the double bond is converted into a single bond by radicals that are excited by active energy such as ultraviolet rays or electron beams to polymerize to server a role of forming a cured structure in the photosensitive electrode composition. The monomer is not particularly limited as long as it is a monomer that is commonly used in the field of photosensitive paste. The monomer may be, for example, a polyfunctional monomer such as bifunctional, trifunctional or tetrafunctional. More specifically, as the polyfunctional monomer, an acrylic ester system selected from trimethylolpropane triacrylate, trimethylolpropane ethoxylated triacrylate, pentaerythritol tri-acrylate or pentaerythritol tetra-acrylate may be used, but the present invention is not limited thereto.

In addition, the monomer may be included in an amount of 10 to 100 parts by weight based on 100 parts by weight of the photosensitive resin. If the content of the monomer is less than 10 parts by weight, the curing density of the exposure pattern may become weak, and if it exceeds 100 parts by weight, the pattern characteristics may be deteriorated, and after curing, there is a concern of increased resistance due to residual organic matter or separation between laminated green sheet layers.

According to an exemplary embodiment of the present invention, similar to the above-described monomer, it may further include an oligomer as a component for forming a cured structure by radicals. The oligomer may be an oligomer that is commonly used in the photosensitive electrode composition without limitation, and it may be, for example, an acrylate having a molecular weight of 1,000 or less. The oligomer may be contained in an amount of 10 to 100 parts by weight based on 100 parts by weight of the photosensitive resin, but the present invention is not limited thereto.

In addition, the photoinitiator is a compound causing a chemical reaction by generating radicals upon irradiation with active energy such as ultraviolet rays or electron beams, and the present invention is not particularly limited as long as it is a photopolymerization initiator that is commonly used in the field of photosensitive electrode compositions. For example, acetophenone compounds, benzophenone compounds, thioxanthone compounds, benzoin compounds, triazine compounds including monophenyl, oxime compounds, carbazole compounds, diketone compounds, sulfonium borate compounds, diazo-based compounds, biimidazole-based compounds and the like may be used as the photoinitiator. Specifically, for the photoinitiator, at least one selected from the group consisting of benzophenone, o-benzoylbenzoic acid methyl, 4,4′-bis(dimethylamino)benzophenone, 4,4′-bis(diethylamino)benzophenone, 4,4′-dichlorobenzophenone, 4-benzoyl-4′-methyldiphenylketone, dibenzylketone, fluorenone, 2,2′-diethoxyacetophenone, 2,2-dimethoxy-2-phenylacetophenone, 2-hydroxy-2-methylpropiophenone, p-t-butyldichloroacetophenone, thioxanthone, 2-methylthioxanthone, 2-chlorothioxanthone, 2-isopropylthioxanthone, diethylthioxanthone, 4-azidobenzalacetophenone, 2,6-bis(p-azidobenzylidene)cyclohexanone, 6-bis(p-azidobenzylidene)-4-methylcyclohexanone, 1-phenyl-1,2-butanedione-2-(o-methoxycarbonyl)oxime, 1-phenyl-propanedione-2-(o-ethoxycarbonyl)oxime, 1-phenyl-propanedione-2-(o-benzoyl)oxime, 1,3-diphenyl-propanetrione-2-(o-ethoxycarbonyl)oxime, 1-phenyl-3-ethoxy-propanetrione-2-(o-benzoyl)oxime, 1,2-octanedione, 1-[4-(phenylthio)-2-(O-benzoyloxime)], 2,4,6-trimethylbenzoyl-diphenyl-phosphine oxide, bis(2,4,6-trimethylbenzoyl)-phenylphosphine oxide, Michler ketone, 2-methyl-[4-(methylthio)phenyl]-2-morpholino-1-propanone, naphthalenesulfonyl chloride, quinoline sulfonyl chloride, N-phenylthioacridone, 4,4′-azobisisobutyronitrile, diphenyl disulfide, benzothiazole disulfide, triphenylphosphine, benzoin peroxide and eosin, photoreducible dyes such as methylene blue, ascorbic acid, and triethanolamine.

The photoinitiator may include 1 to 50 parts by weight based on 100 parts by weight of the binder resin. If the content of the photoinitiator is less than 1 part by weight, there is a concern that the cured density of the exposed portion may decrease, and the cured coating film may be affected in the developing process. In addition, if the content of the photoinitiator exceeds 50 parts by weight, it may be difficult to form a desired pattern due to excessive light absorption in the upper portion of the dry coating film.

Meanwhile, together with the photoinitiator or in place of the photoinitiator, it may include an azide-based photocrosslinker compound, and more specifically, a compound in which both ends of a linear alkylene group having 4 to 20 carbon atoms are substituted with an azide group, which is a photocrosslinkable functional group, and such compounds have the advantage of being able to crosslink without a photoinitiator, thus reducing the amount of photoinitiator. As a specific type thereof, it may be 1,4-diazidobutane, 1,5-diazidopentane, 1,6-diazidohexane, 1,7-diazidoheptane, 1,8-diazidooctane, 1,10-diazidodecane, 1,12-diazidododecane or a mixture thereof.

In addition, the total weight of the binder resin and the monomer including the photosensitive resin described above may be included in an amount of 13 parts by weight or less, more preferably, 10 parts by weight or less, and still more preferably, 2 to 10 parts by weight based on 100 parts by weight of the conductive metal powder. If the binder resin exceeds 13 parts by weight, cracks may occur in the electrode during sintering, or separation between the stacked green sheet layers may be caused in the case of sintering together with the green sheet. In addition, if the binder resin is less than 2 parts by weight, there is a concern that sedimentation of metal powder or ceramic powder in the electrode composition may occur or dispersibility may be impaired, and there is a concern that the electrode may peel off from the sprayed surface after spraying and before drying and sintering.

Meanwhile, it is noted that the specific types of binder resin, monomer and photoinitiator including the above-described photosensitive resin and the contents thereof may be determined by considering the manufacturing method through electrospray, the use of the internal electrode of the laminated ceramic part, the thickness, line width and width of the internal electrode to be implemented, and the material and particle size of the metal powder and ceramic powder.

In addition, the above-described electrode composition or photosensitive electrode composition may further include additives such as a dispersant, a plasticizer, a leveling agent, a thixotropic agent, a slip agent and a curing accelerator in addition to the above-described components, and since the additives may be used without limitation in the case of additives contained in known electrode compositions, the present invention is not particularly limited thereto.

For example, the dispersant is included to impart dispersion stability of the metal powder and the ceramic powder, and is not particularly limited as long as it is a dispersant that is commonly used in the electrode composition. For the dispersant, at least one selected from the group consisting of oleic acid, polyethylene glycol fatty acid ester, glycerin ester, sorbitan ester, propylene glycol ester, sugar ester, fatty acid alkanolamide, polyoxyethylene fatty acid amide, polyoxyethylene alkylamine, amine oxide and poly 12-hydroxystearic acid may be used.

Meanwhile, the additive including the dispersant and the like may be included in an amount of 10 to 50 parts by weight based on 100 parts by weight of the binder resin. If the additive is included in less than 10 parts by weight, it may be difficult to achieve a desired effect through the additive. In addition, if it exceeds 50 parts by weight, there is a concern that physical properties such as conductivity of the electrode composition and thickness uniformity of the dried electrode and/or the sintered electrode implemented after spraying may be deteriorated.

In addition, the electrode composition containing the above-described components may have a viscosity of 50 to 150 cps, and more preferably, 70 to 100 cps, and through this, it is suitable for electrospraying and is advantageous for implementing an ultra-thin dried electrode after electrospraying. If the viscosity is less than 50 cps, precipitation of the dispersed conductive metal powder and ceramic powder may occur rapidly, and there is a concern that the dispersibility may be deteriorated. In addition, if the viscosity exceeds 150 cps, it may be difficult to precisely control the thickness through electrospray, and it may be difficult to manufacture a thin electrode. Meanwhile, herein, the viscosity is the result of measurement with a Brookfield rotational viscometer LV based on ISO 554 under the conditions of a temperature of 25° C., a relative humidity of 65% and 10 rpm.

Meanwhile, the above-described electrode composition may be implemented by mixing the conductive metal powder, ceramic powder, binder resin and solvent, and then dispersing the conductive metal powder and ceramic powder. In this case, since a lot of heat is generated due to the fine powder during mixing and dispersing, it may be more advantageous to mix and disperse by using a high-pressure dispersing device or a bead mill. In addition, it is preferable to maintain the maximum dispersion state until the electrode composition is transferred into the electrospray device and sprayed through the nozzle, and to this end, it may further include a stirring device which is capable of maintaining the dispersion state in the spray solution tank in the electric spray device, and since the stirring device may be a known stirring device such as an impeller and the like, the present invention is not particularly limited thereto.

The above-described electrode composition may be sprayed to have a predetermined electrode pattern on a surface to be sprayed, for example, a ceramic green sheet through a conventional electrospray device, and then dried and sintered to form an electrode. In this case, the average thickness of the electrode during drying may be implemented to be 1 μm or less, and the average thickness after sintering may be implemented to be, for example, 0.3 to 1.0 μm or less.

In addition, the electrode surface of the dried electrode applied to the pattern on which the electrode is formed may have a continuous electrode surface in which an uncoated area does not exist. In addition, it is possible to increase the area such that the area of the continuous electrode surface dried through electrospray on a ceramic green sheet having an area of, for example, 20 cm×20 cm or more may be formed to be 70% or more, preferably, 80% or more, and more preferably, 90% or more of the ceramic green sheet area.

In addition, preferably, after dividing the continuous electrode surface, where the thickness of the dried electrode is measured, into 5 different regions that do not overlap, the thickness uniformity according to Formula 1 below using the average value of the 5 average thicknesses measured for each region and the standard deviation thereof may be within 10%, more preferably, within 5%, and still more preferably, within 3%. Herein, the thickness uniformity (%) means that the less there is a deviation from the average thickness of each area, that is, the closer the standard deviation is to 0, the more excellent the thickness uniformity.

Thickness Uniformity (%)=[(Standard deviation for the average thickness of 5 regions (nm))/(Average value for the average thickness of 5 regions (nm))]×100 [Formula 1]

Meanwhile, the average thickness of the dried electrode or the average thickness of the sintered electrode as defined in the present invention may be measured by a thickness measurement method known as an alpha step, and a known measuring device for measuring the thickness by this method may be used without limitation for thickness measurement.

Meanwhile, it is possible to implement a desired electrode pattern based on known exposure and development conditions before sintering after being electrosprayed with a photosensitive electrode composition for electrospray. For example, as the exposure and development conditions after electrospray, the drying temperature after electrospraying may be 50 to 70° C., and the UV exposure amount may be 100 mJ to 700 mJ. In addition, the developing solution may use, for example, a Na₂CO₃ solution, and the concentration may be 0.1 to 4 wt. %. In addition, the developing time may be 20 to 100 seconds.

### Modes of the Invention

The present invention will be described in more detail through the following examples, but the following examples are not intended to limit the scope of the present invention, which should be construed to aid understanding of the present invention.

### Example 1

A nickel powder having an average particle diameter of 438 nm was prepared through dry plasma. Afterwards, through the wet classification of the prepared nickel powder using centrifugation, a conductive metal with an average particle size of 147.1 nm and a particle size distribution, in which particles with a particle size of two times or more the average particle size accounted for 15% of the total nickel powder and particles with a particle size of 0.5 times or less of the average particle size accounted for 18% of the total nickel powder, was prepared

In addition, a ceramic powder having an average particle diameter of 155 nm as BaTiO₃ was prepared as a ceramic powder, and through wet classification of the same using centrifugation, a ceramic powder with an average particle diameter of 65.8 nm and a particle size distribution, in which particles with a particle size of two times or more of the average particle size accounted for 10% of the total ceramic powder and particles with a particle size of 0.5 times or less of the average particle size accounted for 9% of the total ceramic powder, was prepared

Afterwards, in a mixed solvent in which dihydroterpineol acetate and ethyl acetate were mixed at a weight ratio of 1:1 as solvents, a binder resin containing 45 parts by weight of ethylcellulose with a weight average molecular weight of 40,000 was mixed with 100 parts by weight of the conductive metal powder of nickel with the particle size adjusted as described above, ceramic powder and polyvinyl butyral with a weight average molecular weight of about 70,000. Specifically, based on 100 parts by weight of the conductive metal powder, 6.8 parts by weight of the ceramic powder and 8 parts by weight of the binder resin were mixed such that the weight of the conductive metal powder was 25 wt. % in the total composition, so as to prepare an electrode composition for electrospraying as shown in Table 1 with the viscosity of 80 cps at 25° C.

In this case, the viscosity of the prepared electrode composition for electrospray is the result of measurement with a Brookfield rotary viscometer LV according to ISO 554 under the conditions of a temperature of 25° C., a relative humidity of 65% and 10 rpm.

### Examples 2 to 14

These were prepared in the same manner as in Example 1, except that the content, the average particle diameter and the particle size distribution of the conductive metal powder, the content of the ceramic powder, the average particle diameter and/or the viscosity of the electrode composition were changed as shown in Table 1 or Table 2 below to prepare electrode compositions for electrospraying.

In this case, for the used ceramic powder, a ceramic powder whose particle size was controlled through wet classification to have a particle size distribution, in which particles with a particle size of two times of more of the average particle size were within 10% of the total ceramic powder and particles with a particle size of 0.5 times or less of the average particle size were within 10% of the total ceramic powder, was used.

### Comparative Example 1

It was prepared in the same manner as in Example 1, except that the average particle diameter of the conductive metal powder was changed as shown in Table 1 below to prepare an electrode composition for electrospray.

### Experimental Example 1

A ceramic green sheet with a thickness of 5 μm manufactured from a ceramic slurry with a viscosity of 300 cps, which was prepared by mixing 100 parts by weight of a ceramic part of barium titanate with 10 parts by weight of a polyvinyl butyral binder resin in butyl carbitol acetate as a solvent, was prepared. On the ceramic green sheet, the electrode compositions for electrospraying according to the examples and comparative examples were electrosprayed at a discharge speed (3 mL/min per hole) using an electric spraying device under the conditions of 18° C. and 30% relative humidity such that the air gap, which is the distance between the nozzle and the ceramic green sheet surface, was within 1 μm and the distance between adjacent electrodes was 200 μm or less when dried under the condition that the applied voltage was 70 kV, and then, after drying at 100° C. for 10 minutes, a dried electrode pattern was implemented.

In addition, the electrode pattern in the sintered state was implemented by sintering the ceramic green sheet on which the electrode pattern was formed at 1,000° C. for 2 hours under an atmospheric atmosphere.

Thereafter, the following physical properties were measured for the electrode pattern in the dried state or the electrode pattern in the sintered state, and the results are shown in Table 1 or Table 2 below.

### 1. Average Thickness and Thickness Uniformity

The average thickness was measured by using an alpha-step (Dektak 150, Bruker), which is a stylus-type surface step measuring instrument.

In addition, after dividing the measured electrode surface into 5 regions of the same non-overlapping area and measuring the average thickness for each of the 5 regions, the average thickness of the 5 electrode regions and the standard deviation thereof were calculated to calculate the thickness uniformity according to Formula 1 below.

Thickness uniformity (%)=[(Standard deviation (nm) for average thickness of 5 regions)/(Average value for average thickness of 5 regions (nm))]×100 [Formula 1]

### 2. Continuous Electrode Surface Formability

The dried electrode pattern was observed with an optical microscope, and the area was measured by counting the number of parts where the electrode material was not formed, and it was evaluated as 0 to 5 points according to the following criteria.
5 points if there is no part where the electrode is not formed
The number of parts where electrodes are not formed is 1 to 2 and the area of parts where electrodes are not formed is within 2% of the total area of the observed electrode: 4 points
The number of parts where electrodes are not formed is more than 2 and less than 5, and the electrode non-formed area is within 5% of the total observed electrode area.: 3 points
The number of parts where electrodes are not formed exceeds 5 and within 10, and the electrode non-formed area exceeds 5% to within 10% of the total area of the observed electrode: 2 points
The number of parts where electrodes are not formed exceeds 10 and within 20, and the electrode non-formed area exceeds 5% to within 15% of the total electrode area observed: 1 point

The number of parts where electrodes are not formed exceeds 20, and the electrode non-formed area exceeds 15% of the observed total area of the electrode: 0 points

### 3. Relative Shrinkage Characteristics and Thickness Uniformity of Sintered Electrodes

The shrinkage ratio of the manufactured sintered electrode pattern was measured, and the shrinkage degree of the other examples was expressed as a relative percentage based on the shrinkage value of Example 4 as 100.

In this case, the shrinkage ratio was calculated by measuring the average thickness of the dried electrode and the average thickness of the sintered electrode, and the value calculated by Formula 2 below was used as the shrinkage ratio.

Shrinkage (%)=(Average thickness of electrode after sintering (nm)/Average thickness of electrode after drying(nm))×100 [Formula 2]

In addition, for the thickness uniformity, after dividing the electrode surface where the thickness was measured into 5 random non-overlapping regions ad measuring the average thickness for each of the 5 regions, the average thickness value and standard deviation for the 5 electrode regions were calculated to calculate the thickness uniformity according to Formula 1 described above.

In Tables 1 and 2 below, ‘ratio A’ and ‘ratio B’ refer to the ratio of particles having a particle diameter of two times or more of the average particle diameter of the conductive metal powder and the ratio of particles having a particle diameter of 0.5 times or less of the average particle diameter among the total number of conductive metal powders, respectively. In addition, ‘ratio C’ refers to a value obtained by dividing the average particle diameter of a ceramic powder by the average particle diameter of a conductive metal powder. In addition, the content of the conductive metal powder is a content ratio based on the total weight of the electrode composition for electrospraying, and the content of the ceramic powder is a content based on 100 parts by weight of the conductive metal powder.

TABLE 1

| | | Comparative | | | | | | | |
|---|---|---|---|---|---|---|---|---|---|
| | | Example1 | Example1 | Example2 | Example3 | Example4 | Example5 | Example6 | Example7 |
| Conductive metal | Type/content | 25 | 25 | 25 | 25 | 25 | 25 | 25 | 25 |
| powder | (wt. %) | | | | | | | | |
| | Average | 160.3 | 147.1 | 142.2 | 98.0 | 75.0 | 75.0 | 75.0 | 75.0 |
| | particle | | | | | | | | |
| | diameter (nm) | | | | | | | | |
| | Ratio A (%) | 10 | 15 | 26 | 12 | 9 | 9 | 9 | 9 |
| | Ratio B (%) | 8 | 18 | 23 | 9 | 7 | 7 | 7 | 7 |
| Ceramic powder | Type/content | 6.8 | 6.8 | 6.8 | 6.8 | 6.8 | 6.8 | 6.8 | 6.8 |
| (type/content) | (parts by | | | | | | | | |
| | weight) | | | | | | | | |
| | Average | 75 | 65.8 | 65.8 | 42.2 | 21.8 | 31.1 | 6.5 | 39.8 |
| | particle | | | | | | | | |
| | diameter (nm) | | | | | | | | |
| | Ratio C | 0.47 | 0.45 | 0.46 | 0.43 | 0.29 | 0.41 | 0.087 | 0.53 |

| | | | | | | | | |
|---|---|---|---|---|---|---|---|---|
| Viscosity (cps) | 80 | 80 | 80 | 80 | 80 | 80 | 80 | 80 |
| Average thickness of dried | 750 | 755 | 813 | 586 | 440 | 444 | 440 | 463 |
| electrode (nm) | | | | | | | | |
| Thickness uniformity of dried | 28.40 | 9.30 | 15.9 | 10 | 9.1 | 9.9 | 15.5 | 10.9 |
| electrode (%) | | | | | | | | |
| Maximum thickness in dried | More | Within 1.0 | Within 1.0 | Within 1.0 | Within 1.0 | Within 1.0 | Within 1.0 | Within 1.0 |
| electrode (μm) | than 1.0 | | | | | | | |
| Continuous electrode surface | 3 | 3 | 1 | 4 | 5 | 4 | 4 | 4 |
| formability | | | | | | | | |
| Relative shrinkage | Not | Not | Not | 122 | 100 | 116 | 120 | 147 |
| characteristics of sintered | evaluated | evaluated | evaluated | | | | | |
| electrode | | | | | | | | |
| Thickness uniformity of | Not | Not | Not | 14.3 | 9.6 | 11.8 | 22.9 | 11.2 |
| sintered electrode (%) | evaluated | evaluated | evaluated | | | | | |

TABLE 2

| | | Example8 | Example9 | Example10 | Example11 | Example12 | Example 13 | Example14 |
|---|---|---|---|---|---|---|---|---|
| Conductive metal | Type/content | 35 | 10 | 8 | 25 | 25 | 25 | 25 |
| powder | (wt. %) | | | | | | | |
| | Average | 75.0 | 75.0 | 75.0 | 75.0 | 75.0 | 75.0 | 75.0 |
| | particle | | | | | | | |
| | diameter (nm) | | | | | | | |
| | Ratio A (%) | 9 | 9 | 9 | 9 | 9 | 9 | 9 |
| | Ratio B (%) | 7 | 7 | 7 | 7 | 7 | 7 | 7 |
| Ceramic powder | Type/content | 4.2 | 6.8 | 6.8 | 9.7 | 11.5 | 4 | 2.5 |
| (type/content) | (parts by | | | | | | | |
| | weight) | | | | | | | |
| | Average | 21.8 | 21.8 | 21.8 | 21.8 | 21.8 | 21.8 | 21.8 |
| | particle | | | | | | | |
| | diameter (nm) | | | | | | | |
| | Ratio C | 0.29 | 0.29 | 0.29 | 0.29 | 0.29 | 0.29 | 0.29 |

| | | | | | | | |
|---|---|---|---|---|---|---|---|
| Viscosity (cps) | 94 | 72 | 71 | 84 | 85 | 79 | 79 |
| Average thickness of dried | 44. | 438 | 413 | 445 | 443 | 440 | 426 |
| electrode (nm) | | | | | | | |
| Thickness uniformity of dried | 16.9 | 10 | 24.5 | 9.6 | 9.9 | 9.7 | 17.6 |
| electrode (%) | | | | | | | |
| Maximum thickness in dried | Within 1.0 | Within 1.0 | Within 1.0 | Within 1.0 | Within 1.0 | Within 1.0 | Within 1.0 |
| electrode (μm) | | | | | | | |
| Continuous electrode surface | 3 | 4 | 2 | 4 | 4 | 4 | 2 |
| formability | | | | | | | |
| Relative shrinkage | Not | Not | Not | 108 | 120 | Not | Not |
| characteristics of sintered | evaluated | evaluated | evaluated | | | evaluated | evaluated |
| electrode | | | | | | | |
| Thickness uniformity of | Not | Not | Not | Not | Not | Not | Not |
| sintered electrode (%) | evaluated | evaluated | evaluated | evaluated | evaluated | evaluated | evaluated |

As can be seen from Table 1 and Table 2, in the case of the electrode composition according to Comparative Example 1 containing a conductive metal powder having an average particle diameter of more than 150 nm, the average thickness of the dried electrode was within 1.0 μm, but the thickness uniformity was very poor at 28.40%, and thus, it can be seen that the maximum thickness among the dried electrode thicknesses was greater than 1.0 μm.

Further, in the case of Examples 1 and 2 containing a conductive metal powder having an average particle diameter of 150 nm or less, the maximum thickness of the dried electrode formed after electrospraying was 1.0 μm or less, but in the case of Example 2, particles with a particle size of two times or more of the average particle size amounted to 26% of the conductive metal powder, resulting in a large number of coarse particles, and as a result, the sedimentation speed of the conductive metal powder was fast such that the conductive metal powder was sprayed unevenly into the sprayed solution during electrospraying, and accordingly, it can be seen that the formation of a continuous electrode surface was greatly reduced compared to Example 1.

Meanwhile, in the case of Examples 3 and 4, in which the average particle diameter of the conductive metal powder was provided to be 100 nm or less, the average thickness of the dried electrode implemented during electrospray under the same conditions was thinner than in Example 1, and it can be seen that the thickness uniformity of the dried electrode and the formation of a continuous electrode surface increased.

However, compared to the electrode composition according to Example 3, the electrode composition according to Example 4 further reduced the ratio of particles that was two times or more compared to the average particle diameter of the conductive metal powder such that the content uniformity of the conductive metal powder sprayed during electric spraying increased, and the average particle size of the ceramic powder was further adjusted compared to the average particle size of the conductive metal powder, and accordingly, it can be seen that the thickness uniformity of the dried electrode, the formation of a continuous electrode surface and the shrinkage characteristics and thickness uniformity of the sintered electrode were implemented very excellently.

Further, in Example 6, in which a ceramic powder having an average particle diameter of less than 0.1 times compared to the average particle diameter of the conductive metal powder was mixed, the thickness uniformity of the dried electrode was lowered compared to that of Example 4, and it can be seen that the shrinkage characteristics and thickness uniformity of the sintered electrode deteriorated. Further, in the case of Example 7, in which a ceramic powder having an average particle diameter exceeding 0.5 times compared to the average particle diameter of the conductive metal powder was mixed, it can be seen that the shrinkage characteristics of the sintered electrode greatly deteriorated.

In addition, when the content of the conductive metal powder exceeded 30 wt. %, the increased electrical conductivity of the electrospray composition affected the electrospray such that the continuous electrode surface formability was lowered compared to Example 4, and it can be seen that the thickness uniformity of the dried electrode was also lowered.

Further, even in the case of Example 10, in which the content of the conductive metal powder was less than 10 wt. %, it can be seen that the continuous electrode surface formability and uniformity of dry thickness were lowered compared to Example 9.

Meanwhile, with respect to the content of the ceramic powder, Example 12 containing more than the preferred range significantly increased the shrinkage of the sintered electrode compared to Example 4, and Example 14 containing less than the preferred range had little effect of lowering the electrical conductivity, and thus, it can be seen that the thickness uniformity of the implemented dried electrode was lowered.

### Example 15

It was prepared in the same manner as in Example 1, except that in a mixed solvent in which dihydroterpineol and dihydroterpineol acetate were mixed at a weight ratio of 1:1 to implement a photosensitive electrode composition for electrospraying, the conductive metal powder which is the nickel whose particle size was controlled in Example 1 and a ceramic powder were introduced, a binder resin including 75 wt. % of an acrylate-based copolymer in which 19.5 mol % of methacrylic acid, 38.5 mol % of methyl methacrylate and 42 mol % of isobornyl methacrylate were copolymerized as a photosensitive resin with a weight average molecular weight of about 10,000, 13 parts by weight of pentaerythritol tri-acrylate as a multifunctional monomer based on 100 parts by weight of photosensitive resin, and azobisisobutyronitrile as a photoinitiator were mixed, and specifically, an electrode composition for electrospraying as shown in Table 3 below with a viscosity of 80 cmps at a temperature of 25° C. was prepared by mixing 6.8 parts by weight of the ceramic powder, 8 parts by weight of a total amount of the weights of the binder resin and multifunctional monomer based on 100 parts by weight of conductive metal powder, and 1 part by weight of the photoinitiator based on 100 parts by weight of the photosensitive resin such that the weight of the conductive metal powder in the total composition was 25 wt. %.

In this case, the viscosity of the prepared electrode composition for electrospray is the result of measurement with a Brookfield rotational viscometer LV in accordance with ISO 554 under the conditions of a temperature of 25° C., a relative humidity of 65% and a rotation speed of 10 rpm.

### Examples 16 to 28

These were prepared in the same manner as in Example 15, except that the content of the conductive metal powder, the average particle diameter, the particle size distribution, the content of the ceramic powder, the average particle diameter and/or the viscosity of the electrode composition were changed as shown in Table 3 or Table 4 below to prepare electrode compositions for electrospraying.

In this case, for the used ceramic powder, a ceramic particle whose particle size was controlled through wet classification to have a particle size distribution such that particles with a particle size of two times or more of the average particle size were within 10% of the total ceramic powder and particles with a particle size of 0.5 times or less of the average particle size were within 10% of the total ceramic powder was used.

### Comparative Example 2

It was prepared in the same manner as in Example 15, except that the average particle diameter of the conductive metal powder was changed as shown in Table 3 below to prepare an electrode composition for electrospray.

### Experimental Example 2

After the photosensitive electrode compositions for electrospray according to Examples 15 to 28 and Comparative Example 2 were electrosprayed on the ceramic green sheet used in Experimental Example 1 at a discharge rate (3 mL/min per hole) under the conditions of 18° C. and a relative humidity of 30% by using an electrospray device under the conditions that the air gap, which is the distance between the nozzle and the ceramic green sheet, was 24 cm and the applied voltage was 70 kV, it was dried at 65° C. for 10 minutes, and then, a dried photosensitive electrode layer was implemented.

Afterwards, a mask was placed on the photosensitive electrode layer to have a predetermined electrode line pattern, and then exposed to UV at an intensity of 550 mJ, and development was performed for 30 seconds through a developing solution, which is a 3 wt. % Na₂CO₃ solution, so as to implement an electrode pattern. Thereafter, the ceramic green sheet on which the electrode pattern was formed was sintered at 1,000° C. for 2 hours under an atmospheric atmosphere to implement the electrode pattern in the sintered state.

Thereafter, the following physical properties were measured for the dried photosensitive electrode layer, the developed electrode pattern after exposure or the sintered electrode pattern, and the results are shown in Table 3 or Table 4 below.

In this case, the evaluation methods of (1) the average thickness and thickness uniformity, (2) continuous electrode surface formability for the dried photosensitive electrode layer and (3) the relative shrinkage characteristics and thickness uniformity of the sintered electrode were evaluated in the same manner as in Experimental Example 1.

### (4) Undercut Ratio

After exposure, cross-sections were cut at 10 random points on the developed electrode pattern, and SEM images were photographed to respectively measure the upper and lower widths of the electrode cross-section at each point, and then, after calculating the undercut ratio at each point, which is the percentage of the lower width to the upper width (lower width (μm)×100/upper width (μm)), the average value of the undercut ratios of 10 points was calculated. As the undercut ratio is closer to 100%, it can be evaluated that an electrode of excellent quality has been implemented with good exposure to the lower part of the electrode.

TABLE 3

| | | Comparative | | | | | | | |
|---|---|---|---|---|---|---|---|---|---|
| | | Example2 | Example15 | Example16 | Example17 | Example18 | Example19 | Example20 | Example21 |
| Conductive metal | Type/content | 25 | 25 | 25 | 25 | 25 | 25 | 25 | 25 |
| powder | (wt. %) | | | | | | | | |
| | Average | 160.3 | 147.1 | 142.2 | 98.0 | 75.0 | 75.0 | 75.0 | 75.0 |
| | particle | | | | | | | | |
| | diameter (nm) | | | | | | | | |
| | Ratio A (%) | 10 | 15 | 26 | 12 | 9 | 9 | 9 | 9 |
| | Ratio B (%) | 8 | 18 | 23 | 9 | 7 | 7 | 7 | 7 |
| Ceramic powder | Type/content | 6.8 | 6.8 | 6.8 | 6.8 | 6.8 | 6.8 | 6.8 | 6.8 |
| (type/content) | (parts by | | | | | | | | |
| | weight) | | | | | | | | |
| | Average | 75 | 65.8 | 65.8 | 42.2 | 21.8 | 31.1 | 6.5 | 39.8 |
| | particle | | | | | | | | |
| | diameter (nm) | | | | | | | | |
| | Ratio C | 0.47 | 0.45 | 0.46 | 0.43 | 0.29 | 0.41 | 0.087 | 0.53 |

| | | | | | | | | |
|---|---|---|---|---|---|---|---|---|
| Viscosity (cps) | 80 | 80 | 80 | 80 | 80 | 80 | 80 | 80 |
| Average thickness of dried | 765 | 752 | 810 | 579 | 442 | 444 | 445 | 470 |
| electrode (nm) | | | | | | | | |
| Thickness uniformity of dried | 30.15 | 9.78 | 16.8 | 9.9 | 9.0 | 9.8 | 15.7 | 11.1 |
| electrode (%) | | | | | | | | |
| Maximum thickness in dried | More | Within 1.0 | Within 1.0 | Within 1.0 | Within 1.0 | Within 1.0 | Within 1.0 | Within 1.0 |
| electrode (μm) | than 1.0 | | | | | | | |
| Continuous electrode surface | 3 | 3 | 1 | 4 | 5 | 4 | 4 | 4 |
| formability | | | | | | | | |
| Undercut (%) | 65.8 | 71.5 | 58.9 | 75.0 | 86.6 | 77.1 | 62.4 | 73.5 |
| Relative shrinkage | Not | Not | Not | 120 | 100 | 117 | 122 | 151 |
| characteristics of sintered | evaluated | evaluated | evaluated | | | | | |
| electrode | | | | | | | | |
| Thickness uniformity of | Not | Not | Not | 14.6 | 9.4 | 11.5 | 23.9 | 11.2 |
| sintered electrode (%) | evaluated | evaluated | evaluated | | | | | |

TABLE 4

| | | Example22 | Example23 | Example24 | Example25 | Example26 | Example27 | Example28 |
|---|---|---|---|---|---|---|---|---|
| Conductive metal | Type/content | 35 | 10 | 8 | 25 | 25 | 25 | 25 |
| powder | (wt. %) | | | | | | | |
| | Average | 75.0 | 75.0 | 75.0 | 75.0 | 75.0 | 75.0 | 75.0 |
| | particle | | | | | | | |
| | diameter (nm) | | | | | | | |
| | Ratio A (%) | 9 | 9 | 9 | 9 | 9 | 9 | 9 |
| | Ratio B (%) | 7 | 7 | 7 | 7 | 7 | 7 | 7 |
| Ceramic powder | Type/content | 4.2 | 6.8 | 6.8 | 9.7 | 11.5 | 4 | 2.5 |
| (type/content) | (parts by | | | | | | | |
| | weight) | | | | | | | |
| | Average | 21.8 | 21.8 | 21.8 | 21.8 | 21.8 | 21.8 | 21.8 |
| | particle | | | | | | | |
| | diameter (nm) | | | | | | | |
| | Ratio C | 0.29 | 0.29 | 0.29 | 0.29 | 0.29 | 0.29 | 0.29 |

| | | | | | | | |
|---|---|---|---|---|---|---|---|
| Viscosity (cps) | 94 | 72 | 71 | 84 | 85 | 79 | 79 |
| Average thickness of dried | 440 | 446 | 408 | 450 | 441 | 442 | 428 |
| electrode (nm) | | | | | | | |
| Thickness uniformity of dried | 16.9 | 10.3 | 25.1 | 9.4 | 9.8 | 9.5 | 19.2 |
| electrode (%) | | | | | | | |
| Maximum thickness in dried | Within 1.0 | Within 1.0 | Within 1.0 | Within 1.0 | Within 1.0 | Within 1.0 | Within 1.0 |
| electrode (μm) | | | | | | | |
| Continuous electrode surface | 3 | 4 | 2 | 4 | 4 | 4 | 2 |
| formability | | | | | | | |
| Undercut ratio (%) | 69.8 | 87.5 | 88.6 | 80.5 | 74.8 | 85.6 | 86.0 |
| Relative shrinkage | Not | Not | Not | 110 | 126 | Not | Not |
| characteristics of sintered | evaluated | evaluated | evaluated | | | evaluated | evaluated |
| electrode | | | | | | | |
| Thickness uniformity of | Not | Not | Not | Not | Not | Not | Not |
| sintered electrode (%) | evaluated | evaluated | evaluated | evaluated | evaluated | evaluated | evaluated |

As can be seen from Tables 3 and 4, in the case of the electrode composition according to Comparative Example 2 containing a conductive metal powder having an average particle diameter of more than 150 nm, the average thickness of the dried electrode was within 1.0 μm, but the thickness uniformity was very poor at 28.40%, and accordingly, it can be seen that the maximum thickness of the dried electrode exceeded 1.0 μm.

Further, in Examples 15 and 16 containing a conductive metal powder having an average particle diameter of 150 nm or less, the maximum thickness of the dried electrode formed after electrospraying was 1.0 μm or less, but in the case of Example 16, particles with a particle size of two times or more of the average particle size amounted to 26% of the conductive metal powder, resulting in a large number of coarse particles, and as a result, the sedimentation speed of the conductive metal powder was fast, and thus, the conductive metal powder was sprayed unevenly into the sprayed solution during electrospraying, and accordingly, it can be seen that the continuous electrode surface formability was significantly reduced compared to Example 15. In addition, since the undercut worsened due to insufficient exposure of the lower part of the electrode, it can be seen that the quality of the implemented electrode had deteriorated.

Meanwhile, in the case of Examples 17 and 18, in which the average particle diameter of the conductive metal powder was 100 nm or less, the average thickness of the dried electrode implemented during electrospraying under the same conditions was implemented to be thinner than in Example 1, and it can be seen that the thickness uniformity of the dried electrode and the continuous electrode surface formability increased.

However, in the electrode composition according to Example 18 compared to the electrode composition according to Example 17, the ratio of particles that were two times or more compared to the average particle diameter of the conductive metal powder was further reduced such that the content uniformity of the conductive metal powder sprayed during electrospraying increased, and it was mixed such that the average particle size of the ceramic powder was further controlled compared to the average particle size of the conductive metal powder, and accordingly, it can be seen that the thickness uniformity of the dried electrode, the continuous electrode surface formability and the shrinkage characteristics and thickness uniformity of the sintered electrode were implemented very excellently.

Further, in Example 20, in which a ceramic powder having an average particle diameter of less than 0.1 times of the average particle diameter of the conductive metal powder was mixed, the thickness uniformity of the dried electrode was lowered compared to that of Example 18, and it can be seen that the shrinkage characteristics and thickness uniformity of the sintered electrode were reduced. Further, in the case of Example 21, in which a ceramic powder having an average particle diameter exceeding 0.5 times of the average particle diameter of the conductive metal powder was mixed, it can be seen that the shrinkage characteristics of the sintered electrode deteriorated significantly.

In addition, when the content of the conductive metal powder exceeded 30 wt. %, the increased electrical conductivity of the electrospray composition affected the electrospray such that the continuous electrode surface formability was lowered compared to Example 18, and it can be seen that the thickness uniformity of the dried electrode was also lowered. In addition, it can be seen that the undercut worsened, because exposure of the lower part of the electrode was not performed properly.

Further, in the case of Example 24, in which the content of the conductive metal powder was less than 10 wt. %, it can be seen that the continuous electrode surface formability and uniformity of dry thickness were lowered compared to Example 23.

Meanwhile, with respect to the content of the ceramic powder, in Example 26 containing more than the preferred range, the shrinkage of the sintered electrode was significantly increased compared to Example 18, and in Example 28 containing less than the preferred range, the effect of lowering the electrical conductivity was insignificant, and thus, it can be seen that the thickness uniformity of the implemented dried electrode was lowered compared to that of Example 27.

Although one exemplary embodiment of the present invention has been described above, the spirit of the present invention is not limited to the exemplary embodiments presented herein, and those skilled in the art who understand the spirit of the present invention may easily suggest other exemplary embodiments by changing, modifying, deleting or adding components within the scope of the same spirit, but this will also fall within the scope of the present invention.

What is claimed is:

1. An electrode composition for electrospraying, configured for implementing an electrode having an average thickness of 1.0 μm or less when dried, and comprising a conductive metal powder having an average particle diameter of 150 nm or less, a ceramic powder, a binder resin and a solvent.

2. The electrode composition of claim 1, wherein the electrode composition is configured for implementing an internal electrode of a laminated ceramic part.

3. The electrode composition of claim 1, wherein the conductive metal powder has an average particle diameter of 80 nm or less.

4. The electrode composition of claim 1, wherein in the conductive metal powder, a number of particles having a particle diameter of 2 times or more of the average particle diameter is 20% or less of a total number of conductive metal powders, and a number of particles having a particle diameter of 0.5 times or less of the average particle diameter is 20% or less of the total number of conductive metal powders.

5. The electrode composition of claim 1, wherein the conductive metal powder comprises at least one of a metal selected from the group consisting of Ni, Mn, Cr, Al, Ag, Cu, Pd, W, Mo and Co, an alloy comprising at least one of the metal selected from the group consisting of Ni, Mn, Cr, Al, Ag, Cu, Pd, W, Mo and Co, and a mixed metal comprising at least two of the metal selected from the group consisting of Ni, Mn, Cr, Al, Ag, Cu, Pd, W, Mo and Co.

6. The electrode composition of claim 1, wherein the ceramic powder has an average particle diameter of 0.1 to 0.5 times of the average particle diameter of the conductive metal powder.

7. The electrode composition of claim 1, wherein the ceramic powder comprises at least one ceramic powder selected from the group consisting of titania, alumina, silica, cordierite, mullite, spinel, barium titanate, calcium zirconia and zirconia.

8. The electrode composition of claim 1, wherein the conductive metal powder is provided in an amount of 10 to 30 wt. % based on a total weight.

9. The electrode composition of claim 1, wherein the ceramic powder is comprised in an amount of 4 to 10 parts by weight based on 100 parts by weight of the conductive metal powder.

10. The electrode composition of claim 1, wherein the binder resin is comprised in an amount of 2 to 13 parts by weight based on 100 parts by weight of the conductive metal powder.

11. The electrode composition of claim 1, wherein the binder resin comprises 30 to 60 parts by weight of ethylcellulose based on 100 parts by weight of polyvinyl butyral.

12. The electrode composition of claim 1, wherein the electrode composition comprises a photosensitive resin as a binder resin, and further comprises a monomer and a photoinitiator.

13. The electrode composition of claim 12, wherein a total weight of the binder resin and monomer is comprised in an amount of 2 to 13 parts by weight based on 100 parts by weight of the conductive metal powder.

14. The electrode composition of claim 1, wherein the ceramic powder has an average particle diameter of 45 nm or less.

15. The electrode composition of claim 1, wherein the electrode composition has a viscosity of 50 to 150 cps at 25° C.

16. An electrospray electrode, wherein the electrospray electrode is dried after the electrode composition for electrospraying according to claim 1 is electrosprayed on a predetermined area, and the electrospray electrode has an average thickness of 1 μm or less.

17. The electrospray electrode of claim 16, wherein the electrospray electrode has a thickness uniformity of 10% or less.

18. A laminated ceramic part, comprising:
an internal electrode, wherein the electrospray electrode according to claim 16 is sintered in the internal electrode.

19. The electrospray electrode of claim 16, wherein the electrode composition is configured for implementing an internal electrode of a laminated ceramic part.

20. The electrospray electrode of claim 16, wherein in the electrode composition, the conductive metal powder has an average particle diameter of 80 nm or less.
